(19) United States
(12) Patent Application Publication
(10) Pub. No.: US 2007/0275172 A1
(43) Pub. Date: Nov. 29, 2007

(54) METHODS OF APPLYING HIGH PERFORMANCE COATINGS

(76) Inventors: Rebecca S. Cowles, Wattsburg, PA (US); James R. Halladay, Erie, PA (US); Neil Donovan, Cary, NC (US)

Correspondence Address: LORD CORPORATION;PATENT & LEGAL SERVICES, 111 LORD DRIVE, CARY, NC, 27512, US

(21) Appl. No.: 11/753,797

(22) Filed: May 25, 2007

Related U.S. Application Data
(60) Provisional application No. 60/808,305, filed on May 25, 2006.
(60) Provisional application No. 60/805,362, filed on Jun. 21, 2006.

(51) Int. Cl. B05D 3/12; B05D 3/02; B05D 7/00; C23C 20/00

(52) U.S. Cl. 427/384; 427/430.1; 427/421.1; 427/355; 427/429

(57) ABSTRACT

The present invention relates to coating compositions suitable for coating flexible substrates, such as the myriad molded elastomeric materials in pre-cured or post-cured condition. The coatings are applied to the entire exterior surface thereof. The coating compositions can be applied to shaped or molded articles such as those made from thermoplastic vulcanizates or thermosettable rubber. The coating compositions of the present invention are particularly suitable for coating cured rubber engine mounting devices which are comprised of vulcanized elastomeric parts that have been bonded to metal parts.

### CROSS REFERENCE TO RELATED APPLICATIONS

This application claims the benefit of, and incorporates by reference, U.S. Provisional Patent Application No. 60/808,305 filed May 25, 2006 entitled “APPLICATIONS OF HIGH PERFORMANCE COATINGS”, U.S. Provisional Patent Application No. 60/805,362 filed Jun. 21, 2006 entitled “FLEXIBLE EMISSIVE COATINGS APPLICATION ON PRE-CURED ELASTOMERS”.

### FIELD OF THE INVENTION

The present invention relates to methods of applying high performance elastomeric coatings to various substrates. More particularly, the present invention relates to method of applying coatings comprising a base elastomer and a solvent to various rigid and flexible substrates.

### BACKGROUND OF THE INVENTION

The present invention relates to the coating of flexible substrates with a high performance elastomeric coating. Preferred coatings comprise an elastomer dissolved in a solvent. Particularly preferred coatings comprise those disclosed in U.S. Pat. No. 6,777,026 to Halladay et al. entitled “FLEXIBLE EMISSIVE COATINGS FOR ELASTOMER SUBSTRATES”; U.S. Pat. No. 6,838,407 to Halladay et al. entitled “ROOM TEMPERATURE CURABLE FLUOROPOLYMER COATING”; U.S. Pat. No. 6,844,412 to Halladay entitled “AMBIENT CURED COATINGS AND COATED RUBBER PRODUCTS THEREFROM”; U.S. Pat. No. 7,183,354 to Halladay et al. entitled “ROOM TEMPERATURE FUNCTIONALIZED HNBR COATING”; and U.S. Patent Application Publication No. 2005/0153138 to Halladay et al. entitled “AMBIENT CURED FLEXIBLE FLUOROELASTOMER COATINGS AND COATED PRODUCTS”; all of which are commonly owned by LORD Corporation and are incorporated herein by reference.

An elastomeric part that is subject to elevated temperatures when in use, such as an engine mount structure often comprises a base layer formed from natural rubber, optionally bonded to and/or formed around one or more metal mounting members such as for securing with bolts to the vehicle structure and the engine housing. The base layer is susceptible to degradation caused by heat, oxidation, ozone attack or ultraviolet radiation. It would therefore be desirable to provide a method for applying an elastomeric protective coating which conforms to the contours of the mount where applied and allowed to fully cured after being applied to said base layer, wherein the emissive coating is applied to the base layer such that the operating or equilibrium temperature internal to the rubber portion of the mount, when placed in service, is reduced by at least 30 F. (16 C.), more preferably at least 50 F. (27 C.), and most preferably at least 75 F. (41.6 C.).

### SUMMARY OF THE INVENTION

Coating compositions of the present invention are able to coat flexible substrates, such as the myriad molded elastomeric materials in pre-cured or post-cured condition. The coating is applied to the entire exterior surface thereof. The coating compositions can be applied to shaped or molded articles such as those made from thermoplastic vulcanizates or thermosettable rubber. The coating composition of the present invention is particularly suitable for coating cured rubber engine mounting devices which are comprised of vulcanized elastomeric parts that have been bonded to metal parts.

In a further embodiment of the present invention a method for coating an elastomer article is provided comprising the application of a property enhancing coating (“Coating”) to a less than fully cured elastomer substrate. Prior art methods of coating elastomers include co-extrusion processes resulting in a relatively thick coating (50-60 thousandths of an inch). In contrast, the coating method of the present invention provides a Coating of less than 10/1000 inch, preferably less than 5/1000 of an inch, and most preferably less than 2/1000 inch. Exemplary Coatings include the flexible emissive Coatings disclosed in U.S. Pat. No. 6,777,026 (Appendix A) comprising a copolymer, a curing agent comprising an isocyanate group and a solvent such as MIBK. The method comprises application of the Coating prior to completion of the vulcanization of the substrate. In one embodiment of the present invention, the substrate is uncured when the Coating is applied. In an alternate embodiment of the present invention, the substrate is partially cured prior to application of the Coating.

The Coatings employed in the present invention are typically applied by dipping, spraying, wiping, brushing or the like. Further, the Coatings are preferably applied subsequent to extrusion or molding but prior to a final full cure of the substrate. The Coatings are preferably applied immediately subsequent to extrusion or molding while the part is still warm to use the residual heat of the part to assist curing and adhesion of the coating. In embodiments of the present invention, the Coating may be applied before or after rolling, calendaring, or other pre-forming methods of adjusting shape of elastomer prior to final curing operation.

The method of applying a Coating of an embodiment of the present invention is compatible with the substrates identified herein, including not fully cured elastomers such as include natural rubber, styrene butadiene rubber, polybutadiene rubber, ethylene propylene and ethylene propylene diene rubber, polyisobutylene-isoprene rubber, polychloroprene, low acrylonitrile content (<35 wt. %) nitrile-butadiene rubbers; and the like.

The preferred elastomeric coating compositions are particularly effective as coatings on cured elastomers that have limited oil and solvent resistance. Such elastomers include natural rubber, styrene butadiene rubber, polybutadiene rubber, ethylene propylene and ethylene propylene diene rubber, polyisobutylene-isoprene rubber, polychloroprene, low acrylonitrile content (<35 wt. %) nitrile-butadiene rubbers; and the like. The coating composition may also be used over rigid substrates such as metals, plastics, ceramics, and composites. Examples of thermoplastic and/or thermosetting substrates include, but are not limited to, flexible polyvinyl chloride, PVC-elastomer alloys, like PVC-Nitrile; adhesion promoted or modified polyolefins such as compounded polyethylene and polypropylene; flexible polyesters like PBT, flexible or rubbery polyurethane-, polyurea-, polyurea-rim; fiber reinforced flexible plastics, and cellular vinyl and polyurethane. The coatings are particularly useful for bonded rubber mounts which contain both elastomeric and rigid components. A substrate is considered flexible if the elongation of the substrate material is greater than 25%.

Further examples of commonly available flexible substrates which can be coated with the compositions of the present invention include, but are not limited to, tires, bumpers, wiper blades, vibration isolators, rubber mounts, rail track pad fasteners, helicopter rotor bearings, chassis mounts, wiper frames, gaskets, heels, shoe soles, printing rolls, belts, hoses, fuel tanks, rubber moldings, TPO or TPE molding, facias, and flexible engineered rubber products. In addition to emissive properties the coatings provide improved resistance to oils, solvents, oxygen, ozone and UV light.

The coating composition of the present invention can be applied to one or all sides of a substrate. It is to be understood that occasionally it may be effective for heat dissipation to only coat one side or surface of a substrate which is oriented to a heat source. As stated above, it is advantageous to coat the surfaces of a substrate which are exposed to light, air, oils, and solvents. Obviously, surfaces of a substrate which are not in contact with the same do not necessarily have to be coated. The coating preferably is a continuous coating in film form which completely covers the intended surface of a substrate. The coating is of the aforementioned thickness to cover the desired surface to be protected, but not overly thick to materially alter the mechanical properties of the substrate.

Tire(s) can be coated with a composition of the present invention. It is to be understood that the coating compositions can be utilized to cover the entire outside and/or inside surfaces of a tire. Furthermore, it may also be desired to only coat certain portions of a tire such as the sidewall, tread or the like. Tires generally comprise a tread, a pair of sidewalls which abut the tread in the shoulder regions, a fabric reinforced rubber carcass of generally toroidal shape and one or more plies for supporting the tread and sidewalls, and a circumferential fabric reinforced belt of one or more plies, positioned between the carcass and the tread. Tires generally also include a pair of circumferentially extending bundled wire beads which are substantially inextensible, wherein the carcass extends from one bead to the other and the side edges may be wrapped around the beads as shown. Tires may also include a pair of apex components, preferably of a stiff construction and having a triangular cross section in the region of the beads, and a pair of stiff chaffer components which are positioned in the bead region. The above listed components of the tire are conventional, but it is to be understood that additional parts not listed may be included and parts listed above may be omitted. Tires may also include an inner liner which can be applied to the inner surface of the tire to improve air impermeability. Any tire component or components can be coated with the compositions of the present invention. Preferably, the tread and/or sidewall regions are coated.

### DETAILED DESCRIPTION OF THE INVENTION

Preparation of Elastomer Substrate for Coating

The elastomeric surface or substrate to be coated may optionally be pretreated with a chlorinating agent such as sodium hypochlorite and hydrochloric acid. The use of various chlorinating agents to prepare elastomeric materials for application of a coating composition is well known in the art. One example of a chlorinating agent is commercially available from Lord Corporation under the CHEMLOK® mark such as 7701. The chlorinating agent may be applied to the surface of the elastomeric material by brushing, dipping, spraying, wiping, or the like, after which the chlorinating agent is allowed to dry. Chlorinating agents tend to be very volatile and typically dry within a matter of seconds or minutes.

The coating compositions of the present invention have the surprising ability to form a tenacious bond to flexible elastomeric parts alone, and also to metal components where these are affixed adjacent to the elastomeric part. It is desirable to provide the elastomeric coating over both elastomer and metal so that the boundary between the elastomer and metal can be adequately protected by the coating composition. The present invention is therefore distinguished from many traditional protective coating compositions which only have the ability to bond to one type of substrate to be protected.

A myriad of articles comprising flexible polymers are coated according to the invention. Included are the engineered elastomeric products which are designed to flex and bend, distort, and/or dampen forces including absorbing torque or vibration repeatedly during their service life and are utilized in numerous industrial applications. Specific examples are hoses, seals, mountings, such as engine mounts, dampers and insulating devices, to name a few. In the case of pneumatic tire coatings on the exterior side wall, the invention provides a critical cured elongation of at least 300%, preferably at least 400% by ASTM D-412 elongation test on unsupported cured coating films. As molded parts, like rubber hoses, plastic housings, belts, various mounts, shrouds, seals, grommets, washers, spacers, covers, and housings, etc. which are necessarily rubbery, made of thermoplastic elastomers or of the thermosetting (vulcanized) rubber materials, the adhesion of the coatings is essential as well as the cured physical properties of the coating. The coatings as cured must be capable of 100% elongation, and exhibit no distortion. That is the coatings recover completely when extended up to 100% elongation without cracking or delaminating from the flexible polymer substrate. Coatings on pneumatic, automotive tires, according to the invention exhibit a critical and improved elongation of 300% and above, preferably 400%±50%, as tested according to ASTM-D412 on cured, unsupported coating films.

I. Substrates

HPC coatings can be applied to:
Rubber:
Neoprene, NR, styrene-butadiene, polybutadiene, EPDM, EPR, nitrile, urethane, silicone, styrene butadiene rubber, Hypalon, CSM, CPE, PVC, Santoprene, butyl rubber, thermoplastic elastomers, and thermoplastic vulcanizates. Silicone needs primer before applying the HPC, this application is specific to the HPC patented product.
Polyacrylate
Metal (such as steel and aluminum)
MetalJacket® corrosion control coating
Glass
Plastics

II. Preparation

| Mechanical | Chemical (Primers) |
|---|---|
| GBS | Solvent wipes |
| Grind | Alkaline clean |
| Scuffing hand | Surface treatments |
| H₂O jet | Any primer w/isocyanate reaches |
| | Anything with acid. |
| Plasma | Chlorination chemicals-7701 CX4B |
| | Oxidizing chemicals |
| | Plasma-low pressure gas |
| | Corona-electrical treatment |

Fixturing
Chain-on-edge
Dip line—covered
Spray
Tripod
Blowing it up with an air hose. (Bellows)
   HPC Applications
Spray
Dip
Brush
Tumble spray
Electrostatic spray
Roll coat
Reverse roll coat
Silkscreen
Flow coat
Knife coatings
   Drying/Cure
RT
Forced air oven
Infrared—DONE
Microwave
Induction
Water quench silane
Convention—from inside
Convection—from inside
   Types of Parts HPC Can Be Used On
Hoses
Elastomeric components
Weatherstrip
Seals
Shields
Hoses
Tires
Bellows
Valve stems—polypropylene
Engine mounts
Heat shields (patented)

### HPC Coatings Application Guide

Overview

High Performance Coating (HPC) elastomeric coatings were developed by LORD Corporation for internal use in challenging aerospace applications to increase the service life of elastomeric components in oil, ozone, fuel and general environmental conditions.

The LORD HPC families of elastomer coatings are noted for providing strong adhesion to rubber and metal substrates while maintaining superior tensile and mechanical strength properties. The family consists of three main types primarily differentiated by specific properties incorporated into the material to serve specific applications. There is a clear and black version of each coating. For instance, HPC-3B is B(lack) HPC-3C is C(lear). There is nominal, if any, difference in the handling and application of a B or C coating of the same type.

| Coating | Base | |
|---|---|---|
| Name | Elastomer | Primary Application |
| HPC-3 | FKM | Best fuel, solvent and high temperature |
| | | fluid resistance. |
| HPC-5 | HNBR | General purpose, great ozone |
| | | resistance and good fluid resistance. |
| HPC-6 | AEM | Cosmetic coating that provides |
| | | improved ozone and fluid resistance to |
| | | an existing substrate. Best used where |
| | | the material is needed for cosmetic |
| | | purposes. |
| HRC | AEM | Excellent for radiant heat dissipation. |
| | | Reduces part temperature when cause |
| | | of high temperature is radiant heat |
| | | source. |

This application guide reviews the processes and procedures necessary for successful application of this coating, including how to clean and prepare a surface for bonding a room-temperature-curing elastomeric coating to elastomeric substrate materials, as well as to metallic substrate materials. We recommend a complete review of this application guide before applying the coating.

The pre-coating procedures described herein effectively remove oils, waxes, fillers and plasticizers from the surface of the substrate, enabling superior bonding of the coating. The presence of these additives on a substrate surface can affect the quality of adhesion. In such circumstances, it is vitally important that the surface is properly cleaned and that no blooming of these additives occurs while the coating is curing on the substrate.

The procedures presented result in very high mechanical strength bonds. Many applications may be fine without the levels of adhesion reached by the procedures in this guide. A final process may be simpler than that presented.

Surface Preparation and Application

In most cases, an uncured elastomer coating will be applied to a cured elastomer substrate. The uncured coating then cures and bonds to the substrate elastomer, resulting in high adhesion and mechanical properties for the coating.

The following conditions must occur in order for the coating process to work properly:
1. The substrate must be clean.
2. The correct coating for a given substrate must be used.
3. The coating must be applied properly.
4. The coating must cure properly.

In many cases, two simple techniques can greatly improve the adhesion of the coating. The first is by using heat drying, such as an air oven, set at 121° C. (250° F.) for five minutes, or an infrared curing of similar or shorter time. In all cases, heat drying is the preferred method of application.

The second technique is a “tie coat” process, where an initial coating of one material is placed on the substrate and the final coating of a different material is applied on top. This tie coat process is most often used when a final coat of HPC-3 (FKM) is desired for final product performance but adhesion for a given substrate has been less than perfect. A tie coat (primer coat) of HPC-5 or HPC-6 (depending on the substrate) is applied over the other HPC coating. This has proven to be an effective method to gain exceptional adhesion of the HPC-3 (FKM) topcoat.

Note: Protection against fuel swell will not be effective unless all exposed areas are coated with HPC-3.

General Information for Applying HPC Coatings to Elastomers

1. Cleaning—Substrate surface must be clean. Solvent wipe with methanol or equivalent. Alkaline cleaning, or similar, is acceptable.
2. Substrate Surface Activation—Dip the part in Chemlok 7701 followed by drying at room temperature for 15 minutes. If the substrate is EPDM, dip the polymer in Chemlok 459X.
   Note: “Dipping” into Chemlok 7701 is not practical if applying to many parts.

Often times, it is easiest and best to wipe the surface with a rag saturated with Chemlok 7701. For 459X, small parts like coupons can be dipped, otherwise, it should be brushed on. 459X is a primer and remains on the surface of the EPDM once dried, whereas 7701 is a surface treatment and once flashed is gone.
3. Coating Application—Once the substrate is dry, the desired HPC coating can be dipped, brushed or sprayed. The ideal dry film thickness (dft) of the coatings is:
   HPC-3—0.5 to 1.0 mils (12.7 to 25.4 microns)
   HPC-5—1.0 to 2.0 mils (25.4 to 50.8 microns)
   HPC-6—1.0 to 2.0 mils (25.4 to 50.8 microns)
   HPC-3 using tie coat—0.5 mils (12.7 microns) tie coat, 0.5 mils (12.7 microns) HPC-3.
The number of coats will vary, depending on application method and coating dilution. The goal is the dry film thickness of the coating
4. Coating Curing—The coating can either be dried at room temperature for 24 hours or in a 121° C. (250° F.) oven for 10 minutes.
   Note if Using HPC-6
If a pigment or additive is needed for this application, the HPC-6 solution must be properly mixed and the pigment well dispersed. A paint shaker is a good alternative to hand shaking or mixing with a paint stirrer.
   Note if Using HPC-3
HPC-3 is two part. Mix coating with curative.
HPC-3 can be applied either directly to the substrate or by using HPC-5 as a tie-coat.
If using HPC-5 as a tie coat, the bake step may be omitted and the preferred procedure is as follows:
   1. When dry, the substrate should be dipped, sprayed or brushed with HPC-5. The part can be air dried, with the optimum thickness being 0.4 to 0.6 mils (10.2 to 15.2 microns).
   2. HPC-3 can be applied by brushing, dipping, or spraying once the part is dry.
   3. The part can be room temperature cured for 72 hours or oven cured at 121° C. (250° F.) for ten minutes and kept at room temperature for 24 hours.

Note: For spray application, at least ONE intermittent oven bake is required in order to build film, otherwise, the coating begins to run during spray application.

If using HPC-3 directly, the part should be baked at 121° C. (250° F.) for 10 minutes and let sit for 24 hours after coating to develop max properties.

Adding Pigments and Other Materials to HPC Coatings

The inventors have achieved some desirable attributes with the coating—heat reflective capability and coloring of substrates—through additives to the coatings. In general, the application procedures for coatings with additives are the same as described here.

Preparing the Substrate

Substrate preparation is one of the most important step to quality coating performance. Substrates must be clean and free of organic and inorganic contaminants to ensure optimum adhesion and long term performance.

Metal Surface Preparation

Extensive studies of HPC adhesion to metal surfaces have not been completed to date. The coating will adhere to most clean steel and aluminum and other metal substrates. Following are some general guidelines for metal substrate preparation.

To ensure optimum bond performance and long-term environmental resistance, substrates must be free of organic and inorganic contaminants. Organic materials include grease, dirt and oils which can be removed by solvent or alkaline cleaning. Common inorganic contaminants are rust, scale and oxide layers. These can be cleaned by either abrasion or chemical processes, or a combination of both.

There are a number of ways to prepare substrates for coating application, however, the methods can be broadly divided into mechanical and chemical preparation. Regardless of which method chosen, the essentials of all good surface preparations include:
Removal of all surface contaminants and decomposition products.
Prevention of recontamination.
Careful handling through all processing steps.

Mechanical preparation involves physically removing surface contamination and increasing surface area and substrate profile. These methods include:
Blasting—Abrasive particles (sand, grit or metal oxides) are projected against the surface with a stream of air. Blasting is especially effective for removing inorganic contamination and other corrosion compounds found on metal. The character or quality of the treatment is affected by duration of the blast; shape and size of the blasting media; particle velocity; and the hardness, porosity and other substrate properties.
Abrading—A wire brush or abrasive paper or pad is used to grind the surface. Care must be taken to prevent contamination of the abrasive material and to remove dust and particles after use.
Machining—Cutting tools are used to “score” surfaces. If oils are completely removed, machining produces an excellent bonding surface. However, any oil/grease left on the metal surface may interfere with adhesion.
   Chemical processes, on the other hand, utilize organic and inorganic chemicals to dissolve, suspend or eliminate soils and surface contaminants. Preparation methods include:
Vapor/solvent degreasing—The vapor of solvent or alkaline cleaning solution is utilized to eliminate organic contamination or oils. Because degreasing will not remove scale or corrosion, it's best to use in conjunction with blasting for metal substrates.
Anodizing—Aluminum oxides are electrolytically deposited on bonding surfaces.
Passivation
Zinc phosphating
Alkaline cleaning
Chromate alodizing
Chemical etching
Pickling
   Special Note About Degreasers

Although chlorinated solvents like trichloroethylene and perchloroethylene are still used for degreasing, many companies have discontinued use due to environmental and health-related issues. As a result, many “environmentally friendly” alternatives have been developed, which produce surfaces clean enough for use with adhesive systems. Popular alternatives to chlorinated solvent degreasers include:
Aqueous alkaline cleaning systems, which have been used with solvent-based and aqueous adhesives
Petroleum-based solvents. These materials can be used alone or emulsified to form semi- aqueous systems.
   General Surface Preparation of Metals

The following three-step process is the preferred mechanical surface preparation technique.
Degreasing
Grit-blasting
Degreasing

These methods produce excellent surfaces for coating most substrates. Sometimes, more elaborate chemical methods may be needed for certain substrates or for improved environmental resistance. Regardless of the system, selected parts must remain clean when being removed from the cleaning tank.

Preparing the Coating

Temperature—Temperature affects the viscosity of HPC coatings. If stored cold, allow them to return to the usual working temperature before using. For drums, this may take as long as 48 hours. Recommended storage temperature is 21-27° C. (70-80° F.). Cold storage is not recommended.

Dilution—Regardless of dilution amounts, it is important in all cases that the appropriate diluent be added to the coating while stirring. Mixing guidelines are listed in product bulletins that come with each HPC product.

Pails, Single Gallons and Smaller Containers—Hand stir in a figure “8” motion with a wooden paint stick. For gallon containers, paint shakers may also be used with solvent-based adhesives. Fifteen minutes is usually sufficient. Continue mixing until all settled material is removed from the bottom and the solution has a uniform appearance. Stir frequently during use. To minimize solvent loss, replace the container lid when not in use. Solvent loss reduces ingredient solubility and increases solids content and viscosity.

Drums—HPC products are available in standard 55-gallon drums (208 L) as well as 55-gallon (208 L) units with built-in agitators. The standard drum has two openings in the drum head—¾-inch and 2-inch (1.91 cm and 5.08 cm), while the agitator drum has a 2-inch (5.08 cm) side opening near the drum head outer edge. Regardless of type, all steel drums have protective interior coatings that have been tested for safe storage.

Applying the Coatings

HPC solvent-based coatings may be applied by brushing, dipping, spraying or roll-coating. General recommendations are:
Primer dry film thickness 0.2 to 0.5 mil (5.1 to 12.7 microns)
Covercoat dry film thickness 0.5 to 1.0 mil (12.7 to 25.4 microns)

HPC solvent-based coatings are suitable for hand brushing straight from the can. When using this method, wear cloth gloves and work in a clean environment. Also make sure there are no dirty or greasy objects within reach. When working from small, open containers, solvent evaporation may increase coating solids and the coating can begin to cure. Do not brush back and forth over already applied but still wet coating as the coating will drag on the brush. Get the coating on the part quickly in a uniform thin smooth layer and do not overbrush. If brush strokes become visible on painted parts, dilute the coating to the original viscosity. Brushing is easiest when the viscosity is correct.

Note: Coatings are moisture curable. Thus, it is critical that open containers be protected from sources of moisture. A breeze or fan blowing over an open container of HPC can significantly affect properties. It is best to keep lids on cans and limit air exposure of coating.

Coatings usually dry in 10 to 20 minutes at 21° C. (70° F.). Higher temperatures and/or increased air circulation will accelerate drying time. Baking at 121° C. (250° F.) for five minutes or passing through an IR oven will greatly improve drying and curing time.

Hand-dipping HPC coatings is recommended when only a small number of parts need to be coated or when factory conditions prohibit mechanical units. Withdraw parts from the adhesive slowly to avoid excess coating, sags and drips. Be sure to control the viscosity of the coating.

There are two primary mechanical dipping applications—conveyor equipment and dip tanks. Conventional conveyor equipment is classified as either monorail or bar conveyor systems. The monorail system is a single-chain unit. The bar conveyor is a double-chain assembly with bars running horizontally between the chains. Selection of a conveyor unit depends on the size and number of parts to be dipped. For best results, arrange the conveyor's dipping section so parts are withdrawn at an angle rather than straight up and down. By removing the parts at an angle, the conveyor's forward motion provides a gradual vertical lift, which allows excess fluid to drain evenly from parts.

When using dip tanks, the coating should be agitated continuously, ensuring a good top-to-bottom turnover. The constant motion prevents skinning and sweeps air bubbles to the side. Circulating pumps or submerged impeller agitators are very effective. Diaphragm pumps, if used, should be dual-diaphragm models because of the filler content. Tank depth should only accommodate the largest part to be dipped. Additional depth only increases the volume of the tank and lessens the likelihood of coating turnover. Also, the tank bottom should be slanted so that immersion depth of the parts and the tank depth both decrease as parts move up and out at an angle.

To facilitate coating changing and minimize downtime, tanks should be mobile. If parts are to be partially dipped or if the conveyor's low point is not adjustable, provisions will be needed for raising or lowering the tank. A drip pan behind the dip tank is also recommended. If excess droplets from the parts have not hardened, they may be returned to the tank. However, if the material has solidified, it should be discarded. Other recommendations include:
Equipment made of carbon steel.
Large piping to ensure low-pressure operation.
Solvent-resistant packing or a mechanical seal in all pumps.
Method for agitating contents of the tank.

HPC coatings are moisture cured and cannot be agitated or pumped continuously over indefinite periods without damage. Over-mixing can also cause solvent loss.

To ensure successful dipping, a metal contour or hole should be designed in the part's upper body for securing it to a conveyor hook. The part should hang so drainage is toward a point where the coating tear will not interfere with a critical dimension. Air entrapment can be avoided by changing positions on the conveyor hook. Protruding stud heads that have been welded or swaged into flat plates frequently trap air where the weld is not completely filled. If the stud is at a high stress point, the small void can be the first spot of bond failure. Hand touch-up of critical points may be needed to prevent solvent entrapment.

Soft, rubber caps or thimbles for externally threaded studs, or a cork for tapped holes, are often used to protect threads from adhesive coating. Unfortunately, these protective devices are not always effective. Do not dip if it is important to the function of the part that threads be clean.

Removing metal parts slowly from the coating is critical to dipping success. If removed too quickly, an excessive amount of coating may cling to the part. This excess adhesive drains slowly and unevenly, forming tears, sags and lips on the edges. Collectively, these imperfections reduce aesthetics, prolong drying time and, ultimately, affect the overall molding operation. For optimum results, remove parts slowly and evenly. This allows uniform coating drainage, helping eliminate bond defects. A vertical withdrawal rate of 3 feet (91 cm) per minute is usually satisfactory.

HPC coatings may also be applied through dip-spin coating.

Spray application of coatings is particularly applicable when coating one side or certain areas of a part. When spraying, however, it is important that the coating reach the substrate wet. If drying occurs before reaching the part, adhesion may be poor.

Hand-held guns may be used for small runs, while conveyorized or automated units are effective for large production operations. To reduce overspray, electrostatic units can be employed. For small, intricate parts, an air brush may be used. Regardless of size, properly adjusted equipment ensures delivery of uniform films without sags and tears.

During hand-spray operations, parts are often assembled on racks that incorporate masks wherever needed. If the application requires overall coating, parts can be rotated in front of the spray gun. Chain-on-edge conveyors can be programmed to automatically rotate metals as they pass the guns.

Many manufacturers make paint guns that are also suitable for applying HPC coatings. The preferred system includes:
Gun tips and air caps suited for job-specific volume and spray pattern.
Adjustable air pressure on the liquid supply tank.
Controllable atomizing air pressure on the gun or air source.
Screen (usually 50 mesh) in the liquid line.
Filters and moisture traps in air lines.

Removal of oil and water is critical to preventing contamination. Therefore, the entire spray system should be easy to dismantle and clean. In instances of low-flow equipment, should settling of diluted coating in a flow-restricted area become a problem, it may be necessary to install plumbing which switches to a clean-out solvent every eight hours.

HPC may also be applied through electrostatic spray.

Estimating coverage of sprayed coatings is difficult, as the quantity used depends largely upon the amount of overspray. In many cases, it may be as much as 50%. With electrostatic spraying, however, transfer efficiency may be as high as 75%; thus, a much higher coverage rate can be expected.

Maintaining atomizing air pressure is important to successful spray application. If the pressure is too high, coating droplets may disperse and dry before reaching the part, leaving a dry, dusty appearance. Threads of material will also be seen floating in the spray booth, otherwise known as “cobwebbing.” The problem can be controlled by reducing atomization pressure, further dilution or by using a higher boiling solvent.

Spray-coated parts dry much more quickly than dipped parts, as partial drying occurs during atomization. To properly wet the part, the coating must be fluid when it reaches the substrate. If multiple guns are used, ensure each is applying a wet coat. Do not apply a dry coat with the first gun then cover it with a wet coat.

Roll coating may be used to coat cylindrical or flat objects. Shafts and pipes can be coated by holding them momentarily between two rotating felt rolls that have been dipped in coating. A mohair fabric paint roller can be used to coat large, flat surfaces. However, short nap rollers are preferred.

All HPC solvent-based coatings can be dried at room temperature—10 to 20 minutes at 21° C. (70° F.) is sufficient. Full cure is developed over 24 to 48 hours. If faster drying is necessary, use a circulating air dryer at 120° C. (250° F.). Be sure there is adequate air circulation because the fastest drying occurs when the solvent is removed and begins diffusing through the surface. Air may be recirculated, provided there is enough bleed-off to prevent excessive solvent build-up.

With closed systems, care must be taken to prevent explosive solvent build-ups. For this reason, conveyorized dryers with open ends and crosswise air circulation are most often used. Gas-fired ovens may also be used if they are designed properly. It's also important to purge solvent vapors and unburned gas before restarting gas ovens.

Other effective dryers include steam coils and infrared heat lamps.

Note that coating is both drying (solvent evaporation) and curing during this process.

Part Geometry Considerations

Small parts such as seals can be placed in a basket and dipped into a tank of the coating. Prior to dipping in the coating, these parts will still need to be cleaned with Methanol—either individually or in a process. In order for the parts to be properly cleaned, they may have to be placed in a single layer and not intertwined in a basket initially. The parts can then be placed in a basket and coated with Chemlok 7701 or Chemlok 459X depending on the substrate. Once dry, the parts can then be immersed in a tank of HPC coating. After dipping, the parts should be left in the basket to dry.

For very complex geometry parts, the suggested method is to design a fixture to hold the part. Dip the part in HPC coating and allow to hang dry at room temperature or in an oven bake. It is important to ensure that all the surfaces are clean—the part will have to be hand-cleaned with Methanol prior to dipping into Chemlok 7701 and Chemlok 459X.

For large areas that will be covered, such as a fabric, the coating can be applied without prior need for cleaning. In such applications, the coating can be applied either by spray, brush, or through knife coating. In the latter case, the coating is placed in a trough and the thickness of the coating is adjusted by the gap between the die and the substrate. Adjust either the gap or the speed with which the substrate flows under the coater to get optimum thickness. If the process is fast, the substrate may be passed through some drying ovens to ensure complete cure of the coating. For very large parts, depending on the process, the parts can either be dipped or sprayed with the coating. Several coats may be needed to ensure the desired thickness is achieved.

Handling of Parts

Once the substrate or part has been coated, the correct film thickness on the part should be verified. Ensure that the parts are dry and the coating no longer tacky before handling.

Coating Tips

In the event that the film thickness is too low, the part should be brushed again with the desired coating. For parts that already have HPC-3 on them, there is no reason to re-apply HPC-5, just apply more HPC-3 and follow the drying procedures suggested above.

If the coating on the part looks fine but there seems to be a bare spot, it is best to reapply the coating over the entire part if it was dipped. If brush applied, re-apply over the bare spots. Reapplication across the whole part ensures uniformity.

If the coating seems too thick in some areas, this is not a problem—the coating will still perform well.

Measure the coating thickness on the part at different points to ensure that there is at least 1 to 2 mils (25.4 to 50.8 microns) of dry coating thickness.

All exposed surfaces must have coating on them in order to get optimum performance. For example, for parts that will be immersed in fuel, even having an uncoated area will enable the fuel to enter at that point and seep through the rubber matrix and swell it.

Packaging of Coated Parts

If the parts are dry, they can be individually packaged and shipped. A 24-hour waiting period is recommended to ensure that packaging material does not stick to the coating during shipment. If the parts were coated with HPC-5, wait at least 24 hours prior to stacking. The coating continues to post-cure and absorb moisture during that time period. If the parts were coated with HPC-3 and at room temperature, wait at least 72 hours prior to stacking.

Troubleshooting—Types of Failures and Their Causes

Some primary modes of failure:
Coating delaminates and does not stick.
In fuel immersion, the coating delaminates or swells.
Parts stick together.
Bubbles in coating.
Coating thickness is too thin.
Coating thickness is too thick.
Coating rips over time and exposes a part.
   Potential Solutions to the Failure Coating Does Not Stick To Substrate

Clean the substrate correctly and make sure that there is no waxy residue on the surface or leaching of any additives. It may be necessary to bake the coating at 121° C. (250° F.) for 10 minutes to promote adhesion.

Coating Delaminates

Improper substrate preparation can cause the coating to look like it adhered but can be peeled off over a short period of time. It may be worthwhile to bake the sample in a 121° C. (250° F.) oven for 30 minutes prior to cleaning the substrate to remove whatever additive would leach out. The same may also occur with the use of the HPC-3 coating. This could be caused by the tie-coat delaminating from the substrate. If this happens, peel off the entire coating, prepare the substrate by cleaning with Chemlok 7701 or Chemlok 459X—whichever is appropriate—followed by the coating.

Coating Delaminates or Swells in Fuel Immersion

The correct coating to use for fuel immersion is HPC-3. Use the tie-layer of HPC-5 to obtain the best performance from this coating. Clean the substrate and apply HPC-5 (see application guideline). When dry, apply the appropriate amount of HPC-3. A bake cycle at 121° C. (250 ° F.) for 15 minutes may be needed after coating. If delamination occurs, it may be caused by improper coating of the surfaces or poor adhesion to the substrate initially, in which case, the substrate must be cleaned. If the material already contains both HPC-5 and HPC-3 and delamination still occurs, be sure that the first layer of coating (HPC-5) properly adheres to the substrate and is dry prior to application of the HPC-3.

Part Still Swells in Fuel Immersion

Both HPC-5 and -6 will protect the part from intermittent fuel exposure. Neither coating is designed for immersion of the part in fuel. HPC-3 is the only coating designed for fuel immersion and it may need a tie-coat of HPC-5. To prevent swelling, ensure that all exposed areas are coated first with HPC-5 at the proper thickness and good adhesion is obtained between the substrate and the HPC-5 coating. Once that has been determined, apply HPC-3 to all exposed areas. If any exposed area is not covered with HPC-3, the fuel will enter through that point and cause swelling. Thus, complex geometries with tight bend radiuses may be difficult. Ensure that the correct amount of coating is applied to the part. The coating thickness for HPC-3 needs to be 1.25 mils (31.8 microns) or more.

Parts Stick Together

Parts sticking together are caused by stacking prior to the 24 hour wait period. The parts need to remain unstacked or without touching each other for at least a 24 hour period to enable the coating to fully cure. For HPC-3 coatings, the waiting time period prior to stacking or putting pieces together is closer to 72 hours.

Peeling

Peeling is usually another form of delamination that occurs either upon first application or over time. In such cases, remove the coating, clean and prepare the part thoroughly and re-apply the coating following the correct procedures.

Bubbles Form in Coating

Bubbles in the coating are a form of degassing phenomenon. They may be caused by gasses being released by any of the additives getting trapped between the substrate and the coating during the oven bake cycle. Thus, it is imperative to ensure that there is no leaching or blooming of additives during the cure cycle of the coating.

Bubbles can also be formed when moisture gets trapped in the substrate and released during the oven bake cycle. In such cases, the substrate should be dried prior to application of coating by placing in an oven for four hours at 121° C. (250° F.).

This should only be done if the first application method fails and bubbles occur. It is often not necessary to dry the parts prior to application of the coating. This is also a good method of ensuring that all additives leach out of the substrate prior to application of the coating. The cause of blistering during oven bake is a coating that has been brush applied or dip applied in two steps which haven't been given at least 30 minutes to dry in between steps. Dry for 20 minutes after the second (final) dip or brush before placing in the oven. Solvent must be given plenty of time to evaporate before volatizing it in the oven.

### EXAMPLES

For extruded elastomers, cure profiles are typically high temperature, but short duration. The cure cycles herein typical of conventional systems, but in practice the cure system in the different formulation and the equipment used (i.e. salt bath, hot air tunnel, infra-red, microwave, etc.) will dictate the exact cure cycle conditions. Most coatings of the present invention will cure with almost any cure profile that is sufficient to cure the body of the elastomer. Generally, adhesion is not sensitive to the cure profile, it is sensitive to surface contamination. Therefore, it is preferable to coat at the time of extrusion so that the extrudate has not had time to be contaminated from external sources, nor have internal ingredients had time to bleed to the surface and contaminate it.

| Abbreviation | Constituents |
|---|---|
| HPC-3 | Fluoroelastomer¹ |
| HRC-3 | Fluoroelastomer¹ |
| | Aluminum pigment (10 pbw) |
| HPC-5 | Hydrogenated nitrile rubber |
| HRC-5 | Hydrogenated nitrile rubber |
| | Aluminum pigment (10 pbw) |
| HPC-6 | Ethylene acrylic elastomer² |
| HRC-6 | Ethylene acrylic elastomer² |
| | Aluminum pigment (10 pbw) |

¹such as Tecnoflon ® manufactured by Solvay S.A.
²such as Vamac ® manufactured by DuPont.

Application method:

Brush apply HPC-5C, HPC-6C and HRC-3, HRC-5, HRC-6 and HRC-6 with three times aluminum pigment level, onto hot EPDM directly out of extruder head. Determine effect on water quench before and after Coating application. Determine effect of lube on Coating.

Processes:

Process One—As green EPDM continually feeds out of extruder head, brush coating directly onto 176° F. EPDM. Cut this section out of the line and place on a rack at room temperature. Allow to flash dry at room temperature.
Process Two—As green EPDM continually feeds out of the extruder head cut strip off of the line and immerse in cool tap water for 30 seconds until compound reaches 108F. Brush apply coating onto strip of EPDM and place it on a rack at room temperature.
Process Three—As green EPDM continually feeds out of the extruder head, brush coating onto 176OF compound and then immediately immerse section of EPDM strip that was cut off of the line into cool tap water for 30 seconds. Place on rack at room temperature.
   Ten minutes After Application Test for the Following:
   1. Appearance of Coating on Green Rubber—Preferably no blistering, no orange peel, no wrinkling or other coating defects.
   2. Tack Test of Coating on Green Rubber—is the surface tacky to the touch.
   3. Lube Rub—Coated article is rubbed with the lubricant commonly employed to push the articles onto a mandrel in production before cure.
   4. Tape Adhesion of Coating on Green Rubber and Cured
   Rubber—Apply tape used for ASTM D3359 to an unscored coating, press tape into substrate using tounge depressor or earasor, quickly remove tape in one swift movement at a 45 degree angle from the substrate.
   5. Cross Hatch of Coating on Cured

Rubber Literature claims that a score of 2 or higher is a pass for similar Coatings. The EPDM is cured in a Blue M forced air oven to heat the rubber back up to 176F, cure at 490F for 1 minute, then cure 400F for 4 minutes 30 seconds.

RESULTS OF PROCESS ONE

| | | | | Tape | Tape | Cross |
|---|---|---|---|---|---|---|
| | | Tacky- | | Adhesion | Adhesion | hatch on |
| | Appear- | Yes | Lube | on green | on cured | cured |
| Coating | ance | or No | Rub | rubber | rubber | rubber |
| HRC-6 | Good | No | Pass | 0 | 5 | 0 |
| | | | | Fail | Pass | Fail |
| HRC-5 | Good | No | Pass | 0 | 5 | 5 |
| | | | | Fail | Pass | Pass |
| HRC-3 | Good | No | Pass | 0 | 5 | 3 |
| | | | | Fail | Pass | Pass |
| HRC-6 | Good | No | Pass | 0 | 5 | 0 |
| w/3x Al | | | | Fail | Pass | Fail |
| HPC-6C | Turns | Slight | Pass | Hard | 5 | 0 |
| | glossy | | | to see | Pass | Fail |
| | EPDM | | | clear | | |
| | matte | | | coating | | |
| HPC-5C | Turns | No | Pass | 0 | 5 | 5 |
| | glossy | | | Fail | Pass | Pass |
| | EPDM | | | | | |
| | matte | | | | | |

RESULTS OF PROCESS TWO

| | | | | Tape | Tape | Cross |
|---|---|---|---|---|---|---|
| | | Tacky- | | Adhesion | Adhesion | hatch on |
| | Appear- | yes | Lube | on green | on cured | cured |
| Coating | ance | or no | Rub | rubber | rubber | rubber |
| HRC-6 | Good | No | Pass | 0 | 5 | 0 |
| | | | | Fail | Pass | Fail |
| HRC-5 | Good | No | Pass | 0 | 5 | 5 |
| | | | | Fail | Pass | Fail |
| HRC-3 | Good | No | Pass | 0 | 5 | 4 |
| | | | | Fail | Pass | Pass |
| HRC-6 | Good | No | Pass | 0 | 5 | 0 |
| w/3x Al | | | | Fail | Pass | Fail |
| HPC-6C | Turns | Slight | Pass | Hard | 5 | 4 |
| | glossy | | | to see | Pass | Pass |
| | EPDM | | | clear | | |
| | matte | | | coating | | |
| HPC-5C | Turns | No | Pass | 0 | 5 | 5 |
| | glossy | | | Fail | Pass | Pass |
| | EPDM | | | | | |
| | matte | | | | | |

RESULTS OF PROCESS THREE

| | | | | Tape | Tape | Cross |
|---|---|---|---|---|---|---|
| | | Tacky- | | Adhesion | Adhesion | hatch on |
| | Appear- | yes | Lube | on green | on cured | cured |
| Coating | ance | or no | Rub | rubber | rubber | rubber |
| HRC-6 | Good | Slight | Pass | 0 | 5 | 0 |
| | | | | Fail | Pass | Fail |
| HRC-5 | Good | Slight | Pass | 0 | 5 | 5 |
| | | | | Fail | Pass | Pass |
| HRC-3 | — | — | — | — | — | — |
| HRC-6 | Good | Slight | Pass | 0 | 5 | 0 |
| w/3x Al | | | | Fail | Pass | Fail |
| HPC-6C | Turns | Slight | Pass | Hard | 5 | 4 |
| | glossy | | | to see | Pass | Pass |
| | EPDM | | | clear | | |
| | matte | | | coating | | |
| HPC-5C | Turns | Yes | Pass | 0 | 5 | 5 |
| | glossy | | | Fail | Pass | Pass |
| | EPDM | | | | | |
| | matte | | | | | |

[image]

### CONCLUSIONS

The coatings can be brush applied onto green hoses out of the extruder head without blistering or major appearance issues.
Coating did not come off when rubbed with the lube used to push the hoses onto a mandrel in production before autoclave cure.
HPC-5 had the best adhesion of the three coatings, being the only one to passing crosshatch tape adhesion.
Three times the Aluminum pigment loading in HRC-6 had no noticeable effect on adhesion.
Water quenching the EPDM before and/or after Coating application had no noticeable effect on adhesion.
None of the coatings passed non-cross hatch tape adhesion* test before cure.
All of the coatings passed non-cross hatch tape adhesion testing after cure.
Equipment to apply it on a production line includes, but is not limited to an extruder, calendar, rubber mills, transfer, or injection apparatus.
   (Non-crosshatch means no scoring of the coating with razor blade was done prior to pressing the tape onto the coating.)
   Observations:
HPC-5 and HRC-5 (HPC-5C with silver pigment) were the only coatings to pass crosshatch adhesion after cure.
EPDM used was from GDX 70 durometer compound # 47156
HRC-5 turned yellow on the part.
Temperature ranges of the EPDM before Coating from 108F to 176F had no noticeable effect on coating adhesion.

What is claimed is:

1. A process for coating an elastomer comprising:
a) preparing a coating composition comprising an elastomer dissolved in a solvent; and
b) applying said coating composition to an elastomer.
